(19) United States
(12) Patent Application Publication
(10) Pub. No.: US 2026/0337528 A1
(43) Pub. Date: Oct. 29, 2026

(54) SOLID CLEANING COMPOSITION HAVING AT LEAST ONE CAVITY

(71) Applicant: CAPSUM, MARSEILLE (FR)

(72) Inventors: Sébastien BARDON, VEYRIER DU LAC (FR); Mathieu GOUTAYER, SAINT MALO (FR); Jean-François GONIDEC, AIX-EN-PROVENCE (FR)

(21) Appl. No.: 18/879,666

(22) PCT Filed: Jun. 27, 2023
(86) PCT No.: PCT/EP2023/067501

§ 371 Date: Dec. 27, 2024

(30) Foreign Application Priority Data
Jun. 28, 2022 (FR) 2206461

(51) Int. Cl. C11D 17/00; C11D 1/14; C11D 1/22; C11D 1/37; C11D 3/04; C11D 3/06; C11D 3/08; C11D 3/10; C11D 3/12; C11D 3/20; C11D 3/22; C11D 3/32; C11D 3/386; C11D 3/40; C11D 3/50

(52) U.S. Cl. CPC C11D 17/0065; C11D 1/146; C11D 1/22; C11D 1/37; C11D 3/046; C11D 3/06; C11D 3/08; C11D 3/10; C11D 3/122; C11D 3/2086; C11D 3/2093; C11D 3/225; C11D 3/32; C11D 3/38609; C11D 3/38627; C11D 3/40; C11D 3/50; C11D 2111/12; C11D 2111/14

(57) ABSTRACT

The present invention relates to a solid cleaning composition comprising at least one detergent, in particular a surfactant, characterized in that the composition includes a cavity such that the composition has a porosity of at least 20% by volume relative to the total volume of the solid composition, as well as to associated manufacturing processes.

The disclosure relates to the field of solid cleaning compositions used in particular as household cleaning product and/or detergent. The disclosure particularly relates to solid cleaning compositions comprising one or more detergent surfactants.

At the current time, cleaning compositions are essentially in the form of liquid products, powders to be dispersed, or pods (or sheets) to be dispersed, generally based on a water-soluble polyvinyl alcohol (PVA or PVOH).

Liquid products rely on distribution circuits that are ecologically inappropriate since they are mostly composed of water and therefore are of non-negligible volume and weight.

Powders to be dispersed often lead to the formation of aggregates of hydrated powder which is undesirable. Such aggregates reduce cleaning performance and even, with regard to detergents, form chokepoints which may lead to blockage and even seizing-up of washing-machines.

As for pods, this is an improper ecological solution since once dissolved in water, the polyvinyl alcohol pollutes groundwater.

In addition, regarding the use of single-dose forms, the size and volume of current solid cleaning compositions are generally dictated by the desire for easy prehension by the user. Size and volume are therefore generally larger than is effectively useful to ensure satisfactory cleaning. As a result, a non-negligible part of these solid compositions is in fact dispensable thereby generating much loss and pollution which, for obvious reasons, is not satisfactory at economic and ecological level.

The inventors have ascertained that it is possible to propose solid cleaning compositions that overcome the aforementioned disadvantages, without being detrimental to easy handling by the user and satisfactory cleaning properties.

### Composition

The invention therefore relates to a solid cleaning composition comprising at least one detergent, in particular a surfactant, characterized in that the composition includes a cavity such that said composition has porosity higher than or equal to 20%, preferably higher than or equal to 30%, better still higher than or equal to 40%, in particular higher than or equal to 50%, even higher than or equal to 60%, in particular higher than or equal to 70%, and most particularly higher than or equal to 80% by volume, relative to the total volume of said solid composition.

Therefore, a composition of the invention can still have a size and/or volume similar to those of current solid compositions, but differing through the presence of at least one cavity such that the porosity of said composition is higher than or equal to 20% by volume relative to the total volume of said composition.

By «solid» in the meaning of the invention, it is meant to designate a composition which, at ambient temperature and atmospheric pressure, will not collapse under its own weight. Advantageously, it is meant to designate any composition having a compression strength greater than or equal to 20 g, preferably greater than or equal to 50 g, and better still greater than or equal to 100 g, at ambient temperature (20-25°C), after penetration by a cylinder probe of revolution having a diameter of 0.8 cm into the matrix of the composition to a depth of 1 mm at a rate of 0.5 mm/s and removal of said probe from the matrix of the composition at a rate of 0.5 mm/s, the compression strength being measured with an analyzer of “LFRA Texture Analyzer” type marketed by STEVENS/MECHTRIC.

A composition of the invention is not in the form of a paste. A composition of the invention is not a powdered composition and therefore not in powder form. Finally, a composition of the invention is not a porous solid either derived from agglomeration of powders. In a first embodiment, a composition of the invention is not an expanded composition and is therefore not a foam. In a second embodiment, a composition of the invention can be an expanded composition and can therefore be in the form of a foam.

Preferably, a solid composition of the invention is not coated with a water-soluble coating.

Preferably, a solid composition of the invention is not coated with a water-soluble coating.

By «porosity» in the meaning of the present invention, it is meant to designate the assembly of voids in a solid material, these voids able to filled with fluids, water in particular, when the solid composition is placed in the presence of an aqueous solution e.g. water such as tap water, toilet water, dishwasher water, or washing-machine water.

By «cavity» in the meaning of the present invention, it is meant to designate an empty space inside a solid body and which communicates directly with the outer medium similar to the cavities for example illustrated in FIGS. 1 to 3 and 6. A cavity can indifferently be termed by the words «orifice», «pore» or «hole». Advantageously, said cavity/cavities are through cavities i.e. the cavity designates an empty space inside a solid body and communicates directly with the outer medium either side of the solid body.

Therefore, the volume of said cavity/cavities in a solid composition of the invention represents at least 20%, in particular at least 30%, preferably at least 40%, in particular at least 50%, even at least 60%, in particular at least 70%, and most particularly at least 80% of the volume of said solid composition.

Advantageously, a solid composition of the invention has a density of between 0.2 and 0.8, preferably between 0.3 and 0.7, in particular between 0.4 and 0.6.

A solid composition of the invention can have a total volume of between 0.125 cm³ and 100 cm³, preferably between 0.250 cm³ and 75 cm³, in particular between 0.5 cm³ and 50 cm³, better still between 1 cm³ and 25 cm³, and more particularly between 2.5 cm³ and 15 cm³.

A solid composition of the invention can weigh between 0.025 g and 200 g, preferably between 0.25 g and 150 g, in particular between 0.5 g and 100 g, better still between 1 g and 75 g, more particularly between 2.5 g and 50 g, even between 5 g and 25 g («g» corresponding to the unit «gram»).

In a first preferred embodiment, a solid composition of the invention has a ratio between the volume of the cavities and the total volume of the composition of between 0.05 and 0.9, preferably between 0.1 and 0.8, in particular between 0.2 and 0.9, preferably between 0.2 and 0.8, better still between 0.2 and 0.7, even between 0.2 and 0.6.

By «total volume», it is meant to designate the volume resulting from the sum of the volume of the solid and the volume of the cavities.

In the present invention, the cavities can be said to be macroporous i.e. having pores of minimum width, even diameter, greater than or equal to 0.5 mm, preferably greater than or equal to 0.75 mm, and in particular greater than or equal to 1 mm, even between 0.5 mm and 2 cm, more particularly between 1 mm and 2 cm, preferably between 2 mm and 1 cm, in particular between 3 mm and 75 mm, better still between 4 mm and 50 mm and most particularly between 5 mm and 25 mm.

In particular, the pores have a minimum width, even diameter, of between 0.5 mm and 5 mm, preferably between 1 mm and 3 mm.

In this respect, the Applicant indicates that, at equivalent porosity, the fabrication of a stable solid composition is:
easy in the presence of cavities of small size, for example those contained in solid substrates in which the porosity results from inserting a gas during the production process, similar to the description given in U.S. Pat. No. 8,349,341,
much more difficult in the presence of macroporosities such as those under consideration in the present invention.

The presence of cavities having the content and/or volume and/or size considered above, gives access to solid compositions that are less raw material-intensive whilst still maintaining satisfactory handling properties. A solid composition of the invention is therefore able to generate less loss. This weight gain has the further advantage of allowing less costly transport that is also less polluting. A solid composition of the invention is therefore advantageous both from an ecological and from an economic viewpoint.

Additionally, the inventors have observed an unexpected effect when a solid composition of the invention is placed in the presence of an aqueous phase. The inventors observed that a solid composition of the invention, when in contact with an aqueous phase, produces a greater quantity of foam and more rapidly than a solid composition of same size and volume but devoid of cavities, and even displays faster transformation kinetics between the original solid state into a liquid state e.g. of gel or cream type. Without wishing to be bound by any theory, it is the opinion of the inventors that the presence of cavities in the solid composition allows facilitated transition towards a viscous liquid composition, for example when the solid composition is mixed by hand, or allows an increased contact surface with the aqueous phase, in particular water, and hence better hydration of said solid composition.

Therefore the invention even allows adjustment of the rate at which the solid composition will foam, swell and/or melt, by adjusting the developed surface area at constant volume, by adjusting percent porosity, and more particularly by acting on the shape and/or number and/or size of the cavities, even on the number of walls and/or thickness of the walls of the cavities.

Advantageously, the size and/or volume of the cavities can be adjusted to store and/or react the necessary amount of water to arrive at a final liquid composition having satisfactory/expected properties, even that are optimized and/or homogeneous (i.e. between different single doses) for example in terms of viscosity, hydration, amount of foam formed and/or transformative effect.

With the composition of the invention, it is therefore possible to have access to evanescent compositions, namely able to change into liquid compositions in particular in the form of gels or creams, when in contact with an adequate amount of water.

Finaly the above-described advantages in terms of ability to foam and/or to change into a liquid composition, can additionally require less water consumption, this being an additional advantage from an ecological and economic viewpoint.

The solid nature of a composition of the invention can be based on a phase mostly and even entirely composed of a fatty phase comprising at least one lipophilic gelling agent (also called hereafter «solid fatty phase»).

The solid nature of a composition of the invention can also be based on a phase derived from a saponification (or soap paste compounding) reaction, and therefore result from conversion of a fatty phase comprising at least one oil, preferably vegetable oil, under the action of sodium hydroxide and optionally heat (also called hereafter «soap phase»).

Additionally, the solid nature of the composition of the invention can be based on a phase comprising at least one synthetic detergent (or surfactant) (also called hereafter «SYNDET phase»). As an illustration, it is CETYL ALCOHOL, all or part thereof, which contributes to imparting the solid nature to a SYNDET.

The solid nature of a composition of the invention can therefore be based on (i) a solid fatty phase, (ii) a soap phase and/or (iii) SYNDET phase. In the remainder of the description the «solid fatty phase», «soap phase» and «SYNDET phase» can be commonly designated by the expression «solid phase».

Therefore, a composition of the invention comprises at least one solid phase.

Preferably, a composition of the invention is single-phase, and therefore solely formed of the solid phase.

In one particular embodiment, a composition of the invention may additionally comprise an aqueous phase dispersed in the solid composition, preferably in encapsulated form, in particular as defined below.

Preferably, a composition of the invention is a single-dose composition.

The solid nature of a composition of the invention can result from the presence of at least one gelling agent, preferably heat-sensitive.

A solid composition of the invention can be of any shape, for example spherical, ellipsoid, tetrahedral or polygonal, in particular in the form of a parallelogram, preferably a rectangular parallelogram.

Preferably, in particular to ensure good prehension, a solid composition of the invention has:
a width, or diameter, of between 1 cm and 10 cm, preferably between 2 cm and 8 cm, in particular between 3 cm and 6 cm, and better still between 4 cm and 5 cm; and/or
a height (or thickness) of between 0.5 cm and 5 cm, preferably between 1 cm and 4 cm, and in particular between 2 cm and 3 cm.

The cavity/cavities of a solid composition of the invention can be of any shape e.g. round, oblong, ovoid, triangular, polygonal, in particular hexagonal, honeycomb or tessellated (or partitioned) for example of Voroni diagram type, preferably of honey comb shape such as illustrated in FIGS. 3 and 6.

The cavity/cavities of a solid composition of the invention can also represent letters or the logo of a trademark or company as illustrated in FIG. 2.

A solid composition of the invention comprises one or more cavities, preferably several cavities, the same or different.

In a first variant, a composition of the invention comprises at least one cavity, in particular a through cavity.

In a second preferred variant, a composition of the invention comprises several cavities, through cavities in particular, such as illustrated in FIGS. 3 and 6.

The cavities are through cavities, advantageously along an axis x-x′.

In one particular embodiment, a composition of the invention may comprise at least two cavities that are connected together. Said embodiment is advantageous since it can promote phenomena of capillarity at the time of contact with water, allowing an improvement in the aforementioned technical effects.

Advantageously, a solid composition of the invention comprises several cavities having a structure of honeycomb shape as illustrated in FIG. 3. This honeycomb shape is particularly advantageous in that it permits the manufacture of a solid composition having a ratio of «volume of cavity (cavities)/total volume of the composition» that is most favourable, in particular higher than or equal to 0.5, even higher than or equal to 0.75, without negatively affecting the prehension and robustness of said composition under mechanical stresses likely to be applied thereto and/or during storage. In other words, this honeycomb structure affords an excellent trade-off between cavity volume and mechanical strength.

Advantageously, the cavity/cavities of a solid composition of the invention comprise walls having a thickness of between 10 μm and 1500 μm, preferably between 20 μm and 1000 μm, in particular between 30 μm and 750 μm, more particularly between 50 μm and 500 μm, even between 100 μm and 400 μm. In particular, the cavity/cavities of a solid composition of the invention have walls of a thickness between 250 μm and 500 μm.

Advantageously, a solid composition of the invention comprises several cavities provided with a structure of honeycomb shape having walls with a thickness of between 10 μm and 600 μm, preferably between 20 μm and 500 μm, in particular between 30 μm and 400 μm, more particularly between 50 μm and 300 μm, even between 100 μm and 200 μm.

In one particular embodiment, a composition of the invention may additionally comprise additional patterns separate from the cavities, said patterns possibly being obtained by embossing.

Persons skilled in the art are able to choose the possible constituent compound(s) of a composition of the invention and/or the quantity thereof in such manner that the advantageous properties of a composition of the invention are not or not substantially impaired. Also, those skilled in the art will take care to choose the type and/or quantity of compound(s) having regard to the solid nature, even anhydrous nature if considered, of said composition and/or to the manufacturing process. These adjustments are within the reach of skilled persons.

In particular, a composition of the invention may comprise at least one gelling agent, preferably heat-sensitive.

The gelling agent can be chosen from among hydrophilic gelling agents i.e. soluble or dispersible in water, or lipophilic gelling agents i.e. soluble or dispersible in an oil.

A hydrophilic gelling agent can be chosen from among those described in WO2021234135.

A lipophilic gelling agent can be chosen from among at least one solid fat, preferably chosen from among at least one wax, at least one pasty fat, at least one butter, and mixtures thereof, for example as described in WO2021234135.

Advantageously, a lipophilic gelling agent is a heat-sensitive gelling agent, namely which reacts to heat, and in particular is a gelling agent solid at ambient temperature and liquid at a temperature above 50°C, preferably above 60°C, and better still above 70°C. Preferably, a heat-sensitive gelling agent of the invention has a melting point between 50°C and 130°C, preferably between 60°C and 120°C.

In particular, a composition of the invention may comprise from 10% to 90%, preferably 20% to 80%, in particular 30% to 70%, and better still from 40% to 60% by weight of gelling agent(s) relative to the total weight of the composition.

A composition of the invention may comprise at least one oil, in particular at least one oil able to solubilize fats. By «oil» it is meant a fat liquid at ambient temperature and atmospheric pressure. As oils of the invention, mention can be made for example of:
hydrocarbon oils of vegetable origin;
hydrocarbon oils of animal origin such as perhydrosqualene and squalane;
synthetic esters and ethers, in particular of fatty acids such as the oils of formulas R₁COOR₂ and R₁OR₂ where R₁ is the remainder of a C₈ to C₂₉ fatty acid, and R₂ is a branched or non-branched C₃ to C₃₀ hydrocarbon chain e.g. Purcellin oil, isononyl isononanoate, isodecyl neopentanoate, isostearyl neopentanoate, isopropyl myristate, octyldodecyl myristate, ethyl-2-hexyl palmitate, octyl-2-dodecyl stearate, octyl-2-dodecyl erucate, isostearyl isostearate; hydroxylated esters such as isostearyl lactate, octylhydroxystearate, octyldodecyl hydroxystearate, diisostearyl-malate, triisocetyl citrate, heptanoates, octanoates, fatty alcohol decanoates; polyol esters such as propylene glycol dioctanoate, neopentylglycol diheptanoate and diethyleneglycol diisononanoate; and the esters of pentaerythritol such as pentaerythrityl tetrabehenate (DUB PTB) or pentaerythrityl tetraisostearate (Prisorine 3631);
linear or branched hydrocarbons of mineral or synthetic origin, such as paraffin oils whether or not volatile and derivatives thereof, Vaseline, polydecenes, hydrogenated polyisobutene such as Parleam oil;
fatty alcohols having 8 to 26 carbon atoms such as cetyl alcohol, stearyl alcohol and mixture thereof (cetylstearyl alcohol), or octyldodecanol;
and mixtures thereof.

Preferably, a composition of the invention comprises at least one vegetable oil.

An oil able to solubilize fats is preferably chosen from among the alkyl esters of fatty acids, the mono, di- or triglycerides of fatty acids and fatty alcohol having a chain length of 8 to 16 carbon atoms, preferably 10 to 12 carbon atoms.

In particular, a composition of the invention may comprise from 10% to 90%, preferably 20% to 80%, in particular 30% to 70%, and better still from 40% to 60% by weight of oil(s) relative to the total weight of the composition.

A composition of the invention comprises at least one detergent agent e.g. a surfactant chosen in particular from among a cationic, non-ionic, anionic, amphoteric surfactant, and mixtures thereof.

Said surfactants are chosen from among those usually employed for cleaning compositions. This is particularly the case when the composition of the composition is a SYNDET (term derived from the words «synthetic detergents») also called «soap-free cleanser» or «dermatological cleansing bar».

As anionic surfactants, mention can be made for example of sodium lauryl sulfate, acyl isethionate, sodium alkylsulfosuccinate, sodium cocoyl isethionate or disodium lauryl sulfosuccinate. As cationic surfactants, benzalkonium chloride can be cited for example. As amphoteric surfactants mention can be made of cocamidopropyl betaine, cocoampho-acetate or -diacetate for example.

In one preferred embodiment, a composition of the invention is a SYNDET.

In particular, a composition of the invention may comprise from 1% to 60%, preferably 2.5% to 40%, in particular 5% to 30%, and better still from 10% to 20% by weight of surfactant(s) relative to the total weight of the composition.

A composition of the invention is advantageous in that it permits high concentrations of surfactants. For example, a composition of the invention can comprise at least 30%, preferably at least 40% by weight of surfactants relative to the total weight of the composition.

In a first variant, a composition of the invention is anhydrous. By «anhydrous» in the meaning of the present invention, it is meant to designate a composition which, before any contacting with water, has a water content of less than 5 weight %, preferably less than 1 weight % and in particular less than 0.5 weight %, relative to the total weight of said composition. This is particularly the case when a composition of the invention is a SYNDET.

Optionally, the fatty phase of a composition in this first variant can additionally comprise at least one hydrophilic compound i.e. water-soluble or water-dispersible mixed with said fatty phase.

In a second variant, a composition of the invention comprises a fatty phase and an aqueous phase, one of the two phases able to form a dispersed phase and the other then forming a continuous phase. For example, the dispersed phase is in encapsulated form, for example in the form of matrix spheres (or beads) or of core/shell type (or capsules), for example in the form of capsules as described in WO2010063937.

In one embodiment, the weight percentage of water in the dispersed aqueous phase can be between 0.5 and 50%, preferably between 1 and 40%, in particular between 2.5 and 30%, and better still between 5 and 20% by weight relative to the total weight of the composition.

A composition of the invention, in particular the fatty phase, even the dispersed aqueous phase if any, can additionally comprise at least one additional compound differing from the above-mentioned lipophilic gelling agents, oils and/or detergent agents.

A composition of the invention may additionally comprise an alkaline compound, a complexing agent, sequestering agent, an enzyme, a bleaching agent, an activator, an optical brightener, a polycarboxylate, abrasive particles, descaling agent, sodium bicarbonate, a hydrotrope, softener, adjuvant or co-adjuvant, a preserving agent, an electrolyte, effervescing agent, disintegrating agent, diluent; a disintegration promoter; an essential oil, fragrance, biocide, disinfectant, colouring agent, glitter, a plasticizer, binder, absorbing agent, foaming agent, masking agent and pH adjustor, or any usual cleaning additive, and mixtures thereof.

An alkaline compound increases the efficacy of surfactants by acting on the pH of water so that it remains high, and can be chosen for example from among borates, carbonates, and mixtures thereof.

A complexing agent, or chelating agent or anti-limescale agent traps calcium, increases the efficacy of detergents and can be chosen for example from among citrates, metaphosphates, polyphosphates, zeolites, EDTA (ethylenediaminetetraacetic acid), NTA, (nitrilotriacetic acid), phosphonates, and mixtures thereof.

A sequestering agent, also called an anti-redeposition agent, prevents dirt trapped by the surfactants from redepositing on laundry, and can be chosen for example from among carboxymethylcellulose, phosphonates, and mixture thereof.

An enzyme degrades organic molecules by fractionating these into smaller particles, and can be chosen for example from among lipases and/or proteases. Different enzymes act on various stains: lipases act on fatty stains (lipids), proteases act on protein stains (blood, grass, etc.).

A bleaching agent acts via oxidation or reduction, preferably via oxidation, and can be chosen for example from among perborates, percarbonates, peroxides, such as sodium perborate, sodium percarbonate, hydrogen peroxide, and mixtures thereof.

An activator enables bleaching agents to be more efficient at low temperature. Bleaching activators can be chosen from among bleach precursors, bleach catalysts and mixtures thereof, as described in EP0797656.

An optical brightener absorbs ultraviolet rays and re-emits blue light, so that the surface to be cleaned (or treated), laundry in particular, appears brighter and whiter. In general these are synthetic organic molecules created from derivatives containing aromatic rings, in particular generally derived from two main groups of stilbene derivatives and containing sulfonate groups. These groups comprise distyrylbiphenyl (DSBP) and derivatives of diaminostilbene (DAS). Some other groups include derivatives of coumarins, pyrazoline, benzoxazole, naphthalimide and pyrene. Three molecules in the stilbene family account for the largest world market share: DSBP, DAS1 and DAS2 or 4,4′-bis[(4-(4-sulfoanilino)-6-bis(2-hydroxyethyl)amino-1,3,5-triazin-2-yl)amino]stilbene-2,2′-disulfonate].

Polycarboxylates prevent incrustation and are described in more detail in WO2000043484.

Preferably, the abrasive particles are of plant origin, in particular those described in WO2017009042. Said particles are derived for example from plant materials such as apricot kernels, corncobs, walnut shells or olive stones. To ensure good cleaning performance whilst reducing damage by scratching, the abrasive particles preferably have Mohs hardness of 1 to 7, more preferably Mohs hardness of 2 to 6, and further preferably Mohs hardness of 3 to 5 (kg/mm2).

A hydrotrope for example is a sodium, potassium or ammonium salt, xylenesulfonate, toluenesulfonate, ethylbenzenesulfonate, isopropylbenzenesulfonate, n-amylsulfate and n-hexylsulfonate, urea; or polymeric hydrotropes such as described in EP0797656, and mixtures thereof.

An electrolyte is preferably chosen from among salts (e.g. alkali metal salt), organic and mineral acids. Examples of said electrolyte material are phosphates (e.g. STP), silicates (e.g. metasilicates, disilicates), hypochlorites, carbonates (e.g. bicarbonates and percarbonates), hydroxides, halides (e.g. chlorine), sulfates (e.g. sulfate), sequestering agents (e.g. ethylenediaminetetraacetic acid and sodium nitrilotriacetate), citrates and borates (e.g. perborates). Similarly, the corresponding acids can be used since they are generally converted to an efficient salt form in a non-aqueous liquid product itself, or immediately at the time of dilution in the washing solution.

Advantageously, a composition of the invention additionally comprises at least one effervescing agent and/or at least one disintegrant.

A disintegrating agent can be chosen from among sodium starch glycolates; starch, in particular wheat starch or corn starch; pregelatinized or partially pregelatinized starches; sodium carboxymethyl starch optionally weakly substituted; starches composed of particles of lactose and corn starch; starches composed of pea starch; starches composed of potato starch; starches composed of wheat starch; mannitol disintegrants; crystalline cellulose; microcrystalline cellulose or mixture of microcrystalline cellulose with xanthan gum; sodium carboxymethylcellulose; croscarmellose calcium; croscarmellose sodium; ethylcellulose; substituted hydroxypropyl cellulose; hydroxypropyl methylcellulose; crosslinked polyvinylpyrrolidone; crosslinked polyacrylates, alginic acid and derivatives thereof e.g. sodium alginate; and mixtures thereof.

In particular, a disintegrating agent is chosen for example from among croscarmellose, carboxymethylcellulose, and mixture thereof.

Preferably, the composition comprises between 0.5% and 50%, in particular between 1% and 40%, and better still between 5% and 30% by weight of disintegrating agent(s) relative to the total weight of the composition.

Preferably, a composition of the invention may additionally comprise at least one diluent, preferably chosen from the group formed by microcrystalline cellulose, mannitol, lactose, starch, sodium carbonate, sodium bicarbonate, calcium carbonate, and mixtures thereof. Preferably, the composition has a content of less than 8%, even less than 5% by weight of diluent(s) relative to the total weight of the composition.

Preferably a composition of the invention may additionally comprise at least one disintegration promoter, preferably calcium silicate.

An adjuvant or co-adjuvant is an aminocarboxylate for example, chosen in particular from the group formed by methylglycine diacetic acid (MGDA), iminodisuccinic acid (IDS), glutamic acid diacetate (GLDA), ethylenediaminedisuccinic acid (EDDS), polyaspartic acid, as described in EP3497199.

In particular, a composition of the invention additionally comprises at least one biocide or disinfectant, whereby said composition is then a biocidal, disinfecting, or antimicrobial cleaning composition.

As biocides able to be used in the present invention, mention can be made of strong acids, alkalis, phenolic substances, and oxidizing agents such as peracids and hypohalites. A disinfectant can be chosen for example from among bleach and/or white vinegar.

In particular, a composition of the invention additionally comprises at least one plasticizer and/or at least one binder. This is particularly the case when a composition of the invention is a SYNDET, as previously defined.

A plasticizer particularly allows better extrusion and stamping. As plasticizer, particular mention can be made of long-chain fatty acids (e.g. longer than C16) such as polyol esters, glycerol monostearate, sorbitan stearate, glycol stearate, and mixtures thereof.

A binder can prevent the separation of macroscopic aggregates and hence prevent the onset of cracking in the solid composition.

A composition of the invention may additionally comprise at least sodium lactate and/or at least one salt. Said ingredients have the particular advantage of hardening the composition of the invention.

Advantageously, a solid composition of the invention is not composed of a network of fibres.

Preferably, a composition of the invention does not comprise an alcohol.

Preferably, a solid composition of the invention does not comprise polyvinyl alcohol (PVA or PVOH), a polyacrylate, a copolymer of acrylic acid and methacrylic acid, polyvinylidene fluoride (PVDF), polymethyl methacrylate (PMMA), polyvinylpyrrolidone, polyalkylene oxide, polyacrylonitrile (PES or PAN), polymethacrylate, polyethylene terephthalate, polyethylene, polypropylene, nylon, hyaluronic acid, starch and derivatives thereof, pullulan, gelatin, cellulose (e.g. rayon), hydroxypropylmethylcellulose, methylcellulose, carboxymethylcellulose, cotton, and one of the mixtures thereof.

A composition of the invention does not comprise (or is not based on) a water-soluble solid substrate e.g. of hydrogel type, in particular starch-based and optionally unstructured, and/or poloxamer 407.

A composition of the invention may additionally comprise at least one solvent able to evaporate fully or partially during the production process, as described below. As solvent, mention can be made for example of an apolar or scarcely polar organic solvent, e.g. cyclohexane, THF (tetrahydrofuran), and mixtures thereof.

Evidently, persons skilled in the art will take care to choose any additional compound(s) and/or the quantity thereof in such manner that the advantageous properties of the composition of the invention are not or not substantially impaired by the envisaged addition. Also, skilled persons will take care to choose the type and/or quantity of additional compound(s) according to the aqueous or fatty nature of the phase under consideration and/or having regard to the manufacturing process of the composition. These adjustments are within the reach of skilled persons.

The solid nature of a composition of the invention advantageously obviates the need for conventional packaging. The packaging for a solid composition of the invention can be restricted to a simple paper wrapping.

### Manufacturing Process

A composition of the invention is obtained with any process known to skilled persons and adapted for the manufacture of a solid composition, subject to necessary adaptations to ensure the forming of cavities and hence of meeting the criterion of required porosity.

Preferably the process for manufacturing a solid composition of the invention does not comprise an aeration/injection step of a gas e.g. air, optionally followed by a forming step and drying.

Process n°1

In a first variant, a process for manufacturing a composition of the invention comprises at least the steps of:
(i) providing a composition in liquid or semi-liquid form;
(ii) pouring the composition into a mould and drying until a solid composition is obtained;
(iii) cutting the solid composition to the desired shape; and
(iv) forming cavities to obtain a solid composition of the invention.

In particular, this process for manufacturing a composition of the invention comprises at least the steps of:
(i) providing a fatty phase, a phase derived from a saponification reaction and/or a phase comprising at least one synthetic detergent (or surfactant) (i.e. SYNDET phase), in liquid or semi-liquid form;
(ii) pouring the phase of step (i) into a mould and drying until a solid phase is obtained;
(iii) cutting the solid phase to the desired shape; and
(iv) forming cavities, after which a composition of the invention is obtained.

In one particular embodiment, said manufacturing process is a saponification process (or «soap compounding» process).

Step (i) is advantageously conducted under heat.

Advantageously, steps (iii) and (iv) are simultaneous.

Advantageously, steps (ii), (iii) and (iv) are simultaneous, in which case the shape of the mould is adapted to ensure forming of the cavity/cavities.

Step (iv) is advantageously conducted by means of a punch.

Process n°1 is advantageous in that the offcuts obtained after step (iv) can be reused for further processing. These offcuts can be reheated and fed back into a subsequent n°1 process at step (i) and/or (ii).

Advantageously, when the process is based on a saponification step, a process of the invention may additionally comprise, before step (ii), at least one washing step to remove remaining sodium hydroxide.

Process n°2

In a second variant, a process for the manufacture of a composition of the invention is an extrusion process.

Said manufacturing process of the invention comprises at least the steps of:
(a) providing a composition in liquid or semi-liquid form;
(b) passing the composition of step (a) through an extruding device equipped with a die (or die plate) of adapted shape to form a solid bar; and
(c) cutting the bar obtained at step (b) to obtain a solid composition of the invention.

In particular, this process for manufacturing a composition of the invention comprises at least the steps of:
(a) providing a fatty phase, a phase derived from a saponification reaction and/or a phase comprising at least one synthetic detergent (or surfactant) (i.e. SYNDET phase), in liquid or semi-liquid form;
(b) passing the phase of step (a) through an extruding device equipped with a die (or die plate) of adapted shape to form a solid bar, and
(c) cutting the solid bar obtained at step (b), after which a composition of the invention is obtained.

For obvious reasons, step (b) is performed at a temperature adapted so that the composition is of sufficient viscosity and able to maintain the shape imparted by the die.

For obvious reasons, the shape of the die of the extruding device is also adapted to ensure the formation of the cavity/cavities.

Advantageously, step (b) is conducted at a temperature lower than ambient temperature, for example at a temperature lower than or equal to 15°C, even lower than or equal to 10°C.

At step (b), the extruding device comprises a die having a shape adapted to form the desired cavity/cavities and desired porosity in the solid bar.

As an illustration, an extrusion process of the invention comprises a die such as the one illustrated in FIG. 4.

Step (c) can be performed using a knife or cutting wire such as a butter cutting wire.

Preferably, steps (b) and (c) are simultaneous.

Preferably, the process for manufacturing a composition of the invention is the extrusion process n°2 described above.

In one particular embodiment, applicable to processes n°1 and n°2 described previously, step (i)/(a) entails providing a fluid composition which may comprise at least one solvent able to evaporate in full or in part at step (ii)/(b), even also at step (iii) and/or (iv)/(c).

As solvent, mention can be made for example of an apolar or scarcely polar organic solvent e.g. cyclohexane, THF (tetrahydrofuran), and mixture thereof.

In processes n°1 and n°2 above, when the composition comprises at least one heat-sensitive gelling agent, step (i)/(a) may necessitate heating said composition to a temperature higher than the highest melting point of the heat-sensitive gelling agents contained in said composition.

In one particular embodiment, the extrusion process n°2 can be performed with a 3D printing technique.

### Use

A composition of the invention is dedicated to cleaning, for example for the cleaning of dirt, fat and/or grease stains.

In particular, a composition of the invention is a multi-use cleaner.

In particular, a composition of the invention is a washing-up product and is therefore intended for dish cleaning.

In particular, a composition of the invention is a detergent and is therefore dedicated to the washing of laundry in a washing-machine, or laundry service.

Advantageously, a solid composition of the invention is intended to be placed in contact with an aqueous phase, water in particular, before, simultaneously with, and/or after application thereof to the surface to be treated.

Therefore, in a first embodiment, in particular when a composition of the invention is of single-dose type, the contacting with water is extemporaneous i.e. just before use and/or simultaneously if applied to a wet surface to be cleaned.

In a second embodiment, when a composition of the invention is not of single-dose type, the contacting with water is performed on first use only, and pre-supposes packaging of the «solid composition/water» mixture in a suitable container. For obvious reasons, this necessitates a solid composition having an adapted formula and a sufficient amount of water to ensure transition from a solid composition to a liquid composition, for example in gel form. This also necessitates the presence in the solid composition of at least one preserving agent to guarantee good storage over time of the liquid composition thus formed.

A solid composition of the invention, in particular when having a configuration of honeycomb type as previously described, may comprise a plurality of sections, polygonal sections in particular, each of the sections defining a fractionable perimeter to allow the separating of at least one section from the remainder of the solid composition. Therefore, in this embodiment, each section of the solid composition corresponds to a single dose.

Finally, the present invention also concerns a method for cleaning a surface to be treated, comprising at least one step to apply at least one composition such as defined above to the surface to be treated.

In one particular embodiment, the present invention concerns a product comprising, or derived from the contacting between, at least one first solid composition as described above and at least one second liquid composition.

### First Solid Composition

In the meaning of the present invention, the first composition can indifferently be designated «first solid composition» or «solid composition», and corresponds to a solid composition as described above.

### Second Liquid Composition

In the meaning of the present invention, the second composition can indifferently be designated «second liquid composition» or «liquid composition».

In a first variant, the second composition is aqueous.

In a second variant, the second composition is anhydrous.

In a third variant, the second composition is an emulsion. An emulsion can be a direct (i.e. oil-in-water), invert (i.e. water-in-oil) or multiple emulsion, in particular a double emulsion (i.e. water-in-oil-in-water, oil-in-water-in-oil, or oil-in-oil-in-water).

In one particular embodiment, the second composition is an emulsion, preferably a stable, direct emulsion with high concentration of dispersed phase, and in particular it is an emulsion of HIPE type (i.e. «High Internal Phase Emulsion») or Apollonian emulsion.

A second composition of the invention is not in solid form at ambient temperature and ambient pressure i.e. it is able to flow under its own weight.

A second composition of the invention is in liquid form, preferably in gel form.

The viscosity of a second composition or at least the continuous phase thereof when in emulsion form, may vary extensively which allows varied textures to be obtained. Viscosity is measured at ambient temperature and ambient pressure following the method described in WO2017046305.

For obvious reasons, the viscosity of the second composition is adjusted to allow easy dispensing/application of the product of the invention.

In one embodiment, the viscosity of the second composition is advantageously from 5 000 mPa·s to 500 000 mPa·s, preferably from 10 000 mPa·s to 300 000 mPa·s, better still from 25 000 mPa·s to 100 000 mPa·s, and more particularly from 50 000 mPa·s to 75 000 mPa·s, as measured at 25°C following the above-described method.

Preferably, the second composition can reduce the solidity of the first composition. In particular, the second composition can advantageously comprise at least one raw material able to reduce the solidity of the first composition. This embodiment is advantageous in that it allows the solid texture of the first composition to move towards a softer texture. The term «transformative effect» can be used.

A product of the invention can advantageously have a weight ratio of «first composition(s)/second composition(s)» of between 0.01 and 10, preferably between 0.1 and 5, better still between 0.5 and 1.

In one particular embodiment, the first composition may have high contents of detergent agent(s), in particular of surfactant(s) as described below. The first composition can therefore be termed a «booster».

In the light of the foregoing, a product of the invention is an extemporaneous product i.e. it is the user who, on first use of the product, will place the first composition in contact with the second composition.

The invention therefore also concerns a kit comprising:
at least one first solid composition as previously described;
at least one second liquid composition as previously described; and
optionally, at least one container.

A container can indifferently be designated a «container» or «packaging».

The invention further concerns use of the kit described above, to obtain a product of the invention.

Preferably, a kit of the invention may additionally comprise at least one application/dispensing means.

If the product is intended to be used as household cleaning product and/or detergent, a kit of the invention may additionally comprise at least one means for application to the surface to be cleaned, chosen for example from the group formed by spatulas, different brushes or sponges.

In one particular variant, the kit may comprise several first compositions, the same or different, and/or several second compositions, the same or different, and/or at least one application means.

The invention therefore also concerns a kit comprising several first compositions in the form of single doses comprising detergent agents and/or having contents of different detergent agents.

Therefore, said kit of the invention advantageously allows easy adapting to the effect sought by users.

### DESCRIPTION OF THE FIGURES

FIG. 1 illustrates a composition of the invention of parallelepiped shape having a cavity of cylindrical shape. A corresponds to the side view, and B corresponds to the overhead view.

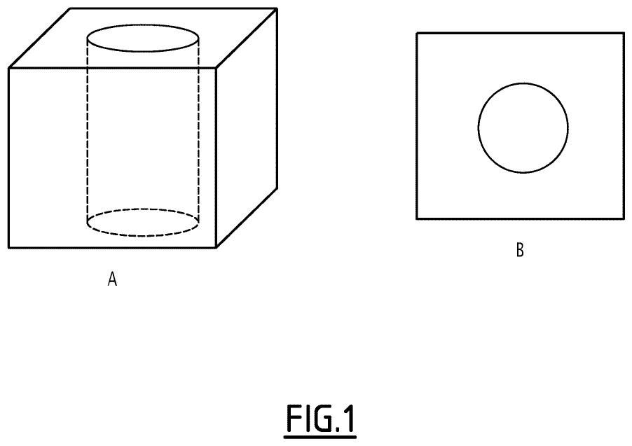

FIG. 2 illustrates a composition of the invention of ovoid shape having cavities (overhead view) representing the word «SOAP».

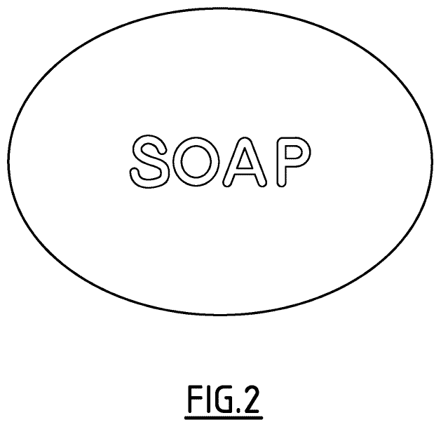

FIG. 3 illustrates a composition of the invention having honeycomb-shaped cavities (overhead view).

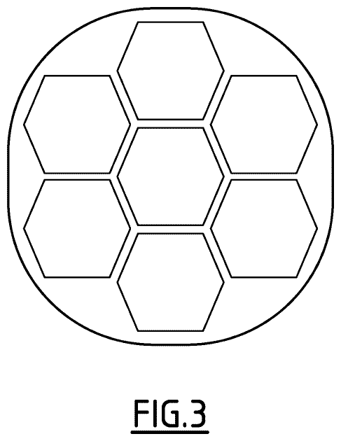

FIG. 4 illustrates a die used for the process of the invention.

FIG. 5 illustrates a comparative die.

FIG. 6 illustrates other examples of solid compositions of the invention.

### EXAMPLES

### Example 1—Comparative Study for Dish Washing

### Step 1—Manufacture:

Using a mixer and hot water bath at 80°C, the raw materials are mixed in the order and in the quantities given in the table below, until a homogeneous mixture is obtained.

TABLE 1

| Name | Weight (in kg) |
|---|---|
| Trisodium citrate | q.s.* |
| Sodium carbonate | 12.80 |
| Sodium silicate | 8.50 |
| Sodium C10-16 alkylbenzenesulfonate | 8.25 |
| Lutensol ® AT 50 | 3.90 |
| Sorbitan stearate | 16.50 |
| Glycol distearate | 14.80 |
| Tetraacetylethylenediamine (TAED) | 3.80 |
| Protease | 4.55 |
| Amylase | 0.80 |
| Blue lake dye E133 | 0.04 |
| Fragrance | 0.06 |
| Total | 100 |

### Step 1—Preparation:

The preparation of the composition described in Table 1 above is within the reach of skilled persons.

### Step 2—Extrusion:

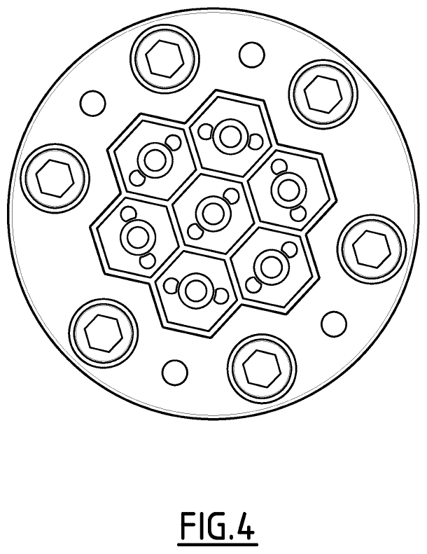

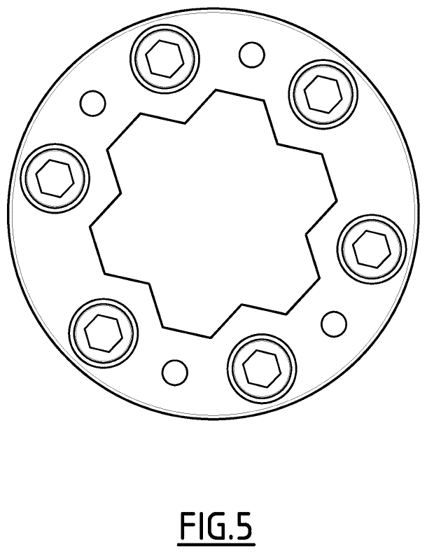

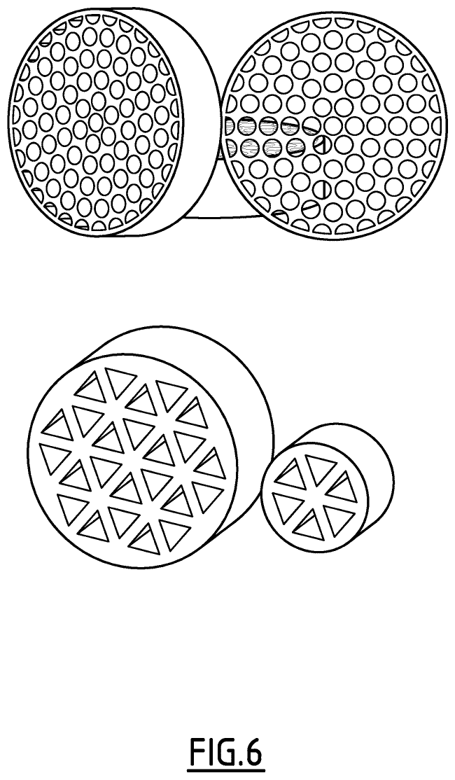

The composition obtained at step 1 is injected into an extruder equipped, in a first case with a die of the invention as illustrated in FIG. 4, and in a second case with a comparative die as illustrated in FIG. 5.
On leaving the die, the extruded bars are cut to obtain the weights and volumes given in Table 2 below.
Single doses are obtained in the form of a solid composition of the invention having a honeycomb structure (dose 1, similar to those described in FIG. 6 for example), and a comparative solid composition is obtained generally having the same shape as dose 1 but devoid of cavity (doses 2 and 3).

TABLE 2

| | Dose 1 | Dose 2 | Dose 3 |
|---|---|---|---|
| | (invention) | (comparative) | (comparative) |
| Weight (in mg) | 250 | 250 | 1000 |
| Volume (in cm³) | 1 | 0.25 | 1 |
| Porosity (%) | >75 | 0 | 0 |

### Step 3—Application:

Step 3 was carried out with a group formed of 36 individuals (women and men) aged between 22 and 47 years (hereafter the «candidates»), 3 sub-groups then being formed, each sub-group comprising 12 individuals (groups A, B and C).

Each of the groups A, B and C used doses 1, 2 and 3 as dishwasher tablets, but each time in a different order.

At this step 3, the candidates assessed the performance of doses 1, 2 and 3 in terms of (i) ease of prehension (ii) dish cleanliness and (iii) state of the dose after use i.e. after a dishwashing cycle.

### Scoring Criteria:

TABLE 3

| | SCORING CRITERIA | | |
|---|---|---|---|
| | 0 | 1 | 2 |
| Prehension | Satisfactory | Moderate | Poor |
| Cleanliness | High | Moderate | Insufficient |
| State of dose | No residue | Some residues | General structure |
| after use | | | retained |

The averages of the results obtained with the three groups A, B and C are given in the following table, on the understanding that the same trends were observed between the three groups.

TABLE 4

| | Dose 1 | Dose 2 | Dose 3 |
|---|---|---|---|
| | (Invention) | (Comparative) | (Comparative) |
| Prehension | 0 | 2 | 0 |
| Cleanliness | 0 | 1 | 1 |
| State after use | 0 | 0 | 2 |

With the conventional doses 2 and 3, it was observed that when the size is too small, prehension is poor and handling is difficult, and if it is too bulky it is not always fully consumed over a dishwasher cycle which is polluting and generates losses.

Dose 1 of the invention allows the combining of all the advantages of the conventional doses 2 and 3, without the disadvantages thereof.

A composition of the invention, through the presence of cavities in the contents under consideration, gives access to solid compositions having satisfactory cleaning properties using less material, while generating less loss and less pollution without being detrimental to handling properties.

A solid composition of the invention is less raw material-intensive and is therefore advantageous both economically and ecologically.

### Example 2—Comparative Study for Washing Laundry

### Step 1—Manufacture:

TABLE 5

| INCI | % |
|---|---|
| Sodium tripolyphosphate | q.s.* |
| Sodium alkane sulphonate | 16.24 |
| Sorbitan stearate | 15.5 |
| Glycol distearate | 14.5 |
| Sodium perborate tetrahydrate | 15.12 |
| Sodium Lauryl Sulfate | 6.3 |
| Sodium carboxymethylcellulose | 1.4 |
| Sodium alkane carboxylate | 1.68 |
| Sodium sulphate | 1.575 |
| Sodium metasilicate | 0.595 |
| Protease | 0.455 |
| Lipase | 0.14 |
| Amylase | 0.14 |
| Tetraacetylethylenediamine (TAED) | 1.575 |
| Sodium C10-16 alkylbenzenesulfonate | 1.505 |
| Fragrance | 0.035 |
| Total | 100 |

*in sufficient amount

The preparation of the composition described in Table 5 above lies within the general knowledge of skilled persons.

### Step 2—Extrusion:

The mixture obtained at step 1 is injected into an extruder equipped in a first case with a die of the invention as illustrated in FIG. 4, and in a second case with a comparative die as illustrated in FIG. 5;
On leaving the die, the extruded bars are cut to obtain the weights and volumes given in Table 6 below.
Solid single-dose compositions are obtained in the form of a solid composition of the invention having a honeycomb structure (dose 1, similar for example to those described in FIG. 6), and a comparative solid composition is obtained having a shape generally similar to that of dose 1 but devoid of cavity (doses 2 and 3).

TABLE 6

| | Dose 1 | Dose 2 | Dose 3 |
|---|---|---|---|
| | (invention) | (comparative) | (comparative) |
| Weight (in mg) | 250 | 250 | 1000 |
| Volume (in cm³) | 1 | 0.25 | 1 |
| Porosity (%) | >75 | 0 | 0 |

### Step 3—Application:

Step 3 was performed with a group comprising 36 individuals (women and men) aged between 22 and 47 years (hereafter the «candidates»), 3 sub-groups then being formed, each group comprising 12 individuals (groups A, B and C).

Each of groups A, B and C used doses 1, 2 and 3 as washing-machine tablets, but each time in different orders.

At this step 3, the candidates assessed the performance of doses 1, 2 and 3 in terms of (i) ease of prehension, (ii) laundry cleanliness and (iii) state of the dose after use i.e. after one washing-machine cycle.

### Scoring Criteria:

TABLE 7

SCORING CRITERIA

| | 0 | 1 | 2 |
|---|---|---|---|
| Prehension | Satisfactory | Moderate | Poor |
| Cleanliness | High | Moderate | Insufficient |
| State of dose | No residues | Some | General structure |
| after use | | residues | retained |

The averages of the results obtained with the three groups A, B and C are given in the following table, on the understanding that the same trends were observed in all three groups.

TABLE 8

| | Dose 1 | Dose 2 | Dose 3 |
|---|---|---|---|
| | (Invention) | (Comparative) | (Comparative) |
| Prehension | 0 | 2 | 0 |
| Cleanliness | 0 | 1 | 1 |
| State after use | 0 | 0 | 2 |

With the conventional doses 2 and 3, it is observed that if the size is too small, prehension is poor and handling is difficult, and if the dose is too bulky it is not always fully consumed over a washing-machine cycle, generating pollution and losses.

Dose 1 of the invention allows combining of the advantages of the conventional doses 2 and 3. without the disadvantages thereof.

A composition of the invention, through the presence of cavities in the contents under consideration, gives access to solid compositions having satisfactory cleaning properties with less raw material, whilst generating less loss and pollution, without being detrimental to handling properties.

A solid composition of the invention is therefore less raw material-intensive and is therefore advantageous both economically and ecologically.

What is claimed is:

1. A solid cleaning composition comprising at least one detergent agent, characterized in that the composition includes at least one cavity such that said composition has porosity higher than or equal to 20% by volume relative to the total volume of said solid composition.

2. The solid composition according to claim 1, wherein the porosity is higher than or equal to 30% by volume relative to the total volume of said solid composition.

3. The solid composition according to claim 1, wherein said cavity/cavities are through cavities.

4. The solid composition according to claim 1, said composition comprising one or more cavities.

5. The solid composition according to claim 1, wherein the shape of the cavity/cavities is round, oblong, ovoid, triangular, polygonal, honeycomb or of tessellated shape (or partitioned).

6. The solid composition according to claim 1, wherein the ratio between the volume of the cavity/cavities and the total volume of the composition is between 0.2 and 0.9.

7. The solid composition according to claim 1, wherein said composition comprises at least one gelling agent.

8. The solid composition according to claim 1, wherein said composition is a single-dose composition.

9. The solid composition according to claim 1, wherein the composition comprises at least one cationic, non-ionic, anionic, amphoteric surfactant, and mixtures thereof.

10. The solid composition according to claim 1, wherein the composition additionally comprises at least one additional compound chosen from among an alkaline compound, a complexing agent, sequestering agent, an enzyme, bleaching agent, activator, optical brightener, a polycarboxylate, abrasive particles, descaling agent, sodium bicarbonate, a hydrotrope, softener, adjuvant or co-adjuvant, a preserving agent, an electrolyte, effervescing agent, disintegrating agent, diluent, a disintegration promoter, an essential oil, fragrance, biocide, a disinfectant, colouring agent, glitter, a plasticizer, binder, an absorbing agent, foaming agent, masking agent, pH adjuster, or any usual cleaning additive and mixtures thereof.

11. A kit comprising:
at least one first solid composition according to claim 1;
at least one second liquid composition; and
optionally at least one container.

12. A process for manufacturing a solid composition according to claim 1, comprising at least the steps of:
(i) providing a fatty phase, a phase derived from a saponification reaction and/or a phase comprising at least one synthetic detergent (or surfactant) (i.e. a SYNDET phase), in liquid or semi-liquid form;
(ii) pouring the phase of step (i) into a mould and drying until a solid phase is obtained;
(iii) cutting the solid phase to the desired shape; and
(iv) forming cavities, whereby a composition according to claim 1 is obtained.

13. A process for manufacturing a solid composition according to claim 1, comprising at least the steps of:
(a) providing a fatty phase, a phase derived from a saponification reaction and/or a phase comprising at least one synthetic detergent (or surfactant) (i.e. SYNDET phase), in liquid or semi-liquid form;
(b) passing the phase of step (a) through an extrusion device equipped with a die (or die plate) of adapted shape to form a solid bar; and
(c) cutting the solid bar obtained at step (b), whereby a solid composition is obtained according to claim 1.

14. A method for cleaning a surface to be cleaned, comprising at least one step to apply to the surface to be cleaned at least one composition according to claim 1.
